(19) United States
(12) Patent Application Publication
(10) Pub. No.: US 2016/0380500 A1
(43) Pub. Date: Dec. 29, 2016

(54) CONDUCTOR WIRE, ELECTRIC MOTOR, AND ELECTRIC MOTOR MANUFACTURING METHOD

(71) Applicant: MITSUBISHI ELECTRIC CORPORATION, Chiyoda-ku, Tokyo (JP)

(72) Inventors: Keiichiro OKA, Chiyoda-ku, Tokyo (JP); Kazuyuki YAMAMOTO, Chiyoda-ku, Tokyo (JP); Hiroyuki AKITA, Chiyoda-ku, Tokyo (JP)

(73) Assignee: MITSUBISHI ELECTRIC CORPORATION, Chiyoda-ku Tokyo (JP)

(21) Appl. No.: 15/038,825

(22) PCT Filed: Jan. 27, 2014
(86) PCT No.: PCT/JP2014/051662

§ 371 Date: May 24, 2016

(51) Int. Cl. H02K 3/32; H02K 3/04; H02K 15/00; H01B 7/02

(52) U.S. Cl. CPC H02K 3/32; H01B 7/02; H02K 3/04; H02K 15/0081

(57) ABSTRACT

A cold-welded conductor wire has a connection portion formed by a first conductor wire and a second conductor wire being connected by cold welding, and has: a bent portion bent at a location different from the connection portion; and an insulating case formed by an insulating sheet wrapping the connection portion and being bonded.

### TECHNICAL FIELD

The present invention relates to a cold-welded conductor wire, an electric motor, and an electric motor manufacturing method that enable the quality of a connection portion to be ensured in a simple manner and with low cost.

### BACKGROUND ART

A conventional cold-welded conductor wire is formed by bending a conductor connection portion connected by cold welding and then covering the bent portion with a cap (for example, see Patent Document 1).

As a general insulating structure other than the cap, the entire connection portion is covered with a heat shrink tube, and the heat shrink tube is heated and shrunk to be fixed, thus forming an insulating structure of the connection portion.

### CITATION LIST

### Patent Document

Patent Document 1: Japanese Laid-Open Patent Publication No. 8-168160

### SUMMARY OF THE INVENTION

### Problems to be Solved by the Invention

The conventional cold-welded conductor wire is formed by bending the connection portion connected by cold welding. Therefore, tensile stress occurs at the connection portion and a hardened portion near the connection portion. As a result, at the connection portion and the hardened portion near the connection portion, deformation or crack occurs, or minute internal flaw grows. Thus, there is a problem of causing concern about such damages.

When the heat shrink tube is heated and shrunk, the heat shrink tube is not positioned and fixed with respect to the connection portion. Therefore, the connection portion which should be insulated might be exposed out of the heat shrink tube. Thus, there is a problem of causing concern about the insulation quality of the connection portion.

In order to solve this, by performing a heat shrink process while carefully confirming the position of the heat shrink tube, the insulation quality of the connection portion can be ensured. However, it is necessary to cover the wire with the heat shrink tube before the wire is connected by cold welding, and a time for heating and cooling is needed. Thus, the number of working steps and the working time are increased, resulting in a problem of deterioration in the working efficiency and the productivity.

In addition, since the cost of the heat shrink tube is high, there is a problem of increasing the material cost for the electric motor.

The present invention has been made to solve the above problems, and an object of the present invention is to provide a cold-welded conductor wire, an electric motor, and an electric motor manufacturing method that enable the quality of the connection portion to be ensured in a simple manner and with low cost.

### Solution to the Problems

A cold-welded conductor wire of the present invention is a cold-welded conductor wire having a connection portion formed by two conductor wires being connected by cold welding, the cold-welded conductor wire including: a bent portion bent at a location different from the connection portion; and an insulating case formed by an insulating sheet wrapping the connection portion and being bonded.

An electric motor of the present invention is an electric motor having a winding coil and an external lead wire, the electric motor including: a connection portion formed by a lead wire of the winding coil and the external lead wire being connected by cold welding; a bent portion bent at a location different from the connection portion; and an insulating case formed by an insulating sheet wrapping the connection portion and being bonded.

An electric motor manufacturing method of the present invention is a manufacturing method for an electric motor having an electric motor winding coil and an external lead wire, the manufacturing method including: a step of connecting a lead wire of the winding coil and the external lead wire by cold welding, to form a connection portion; a step of bending a part different from the connection portion, to form a bent portion; and a step of covering the connection portion with an insulating sheet so as to be wrapped and bonding the insulating sheet, to form an insulating case.

### Effect of the Invention

Owing to the above configurations, the cold-welded conductor wire, the electric motor, and the electric motor manufacturing method of the present invention enable the quality of the connection portion to be ensured in a simple manner and with low cost.

### BRIEF DESCRIPTION OF THE DRAWINGS

FIG. 1 is a perspective view showing the configuration of a cold-welded conductor wire in embodiment 1 of the present invention.

FIG. 2 is a perspective view showing the configuration of a cold welding die used in cold welding of the cold-welded conductor wire shown in FIG. 1.

FIG. 3 is an exploded view showing the configuration of the cold welding die shown in FIG. 2.

FIG. 4 is a diagram showing a manufacturing method for the cold-welded conductor wire shown in FIG. 1.

FIG. 5 is a diagram showing the manufacturing method for the cold-welded conductor wire shown in FIG. 1.

FIG. 6 is a diagram showing the manufacturing method for the cold-welded conductor wire shown in FIG. 1.

FIG. 7 is a diagram showing the manufacturing method for the cold-welded conductor wire shown in FIG. 1.

FIG. 8 is a diagram showing the manufacturing method for the cold-welded conductor wire shown in FIG. 1.

FIG. 9 is diagram showing the manufacturing method for the cold-welded conductor wire shown in FIG. 1.

FIG. 10 is a diagram showing the manufacturing method for the cold-welded conductor wire shown in FIG. 1.

FIG. 11 is a diagram showing the manufacturing method for the cold-welded conductor wire shown in FIG. 1.

FIG. 12 is a diagram showing the manufacturing method for the cold-welded conductor wire shown in FIG. 1.

FIG. 13 is a diagram showing the manufacturing method for the cold-welded conductor wire shown in FIG. 1.

FIG. 14 is a diagram showing the manufacturing method for the cold-welded conductor wire shown in FIG. 1.

FIG. 15 is a diagram showing the manufacturing method for the cold-welded conductor wire shown in FIG. 1.

FIG. 16 is a diagram showing the manufacturing method for the cold-welded conductor wire shown in FIG. 1.

FIG. 17 is a diagram showing the manufacturing method for the cold-welded conductor wire shown in FIG. 1.

FIG. 18 is a side view showing the configuration in which the cold-welded conductor wire shown in FIG. 1 is used for an electric motor.

FIG. 19 is a top view showing the electric motor shown in FIG. 18 to which a fixing portion is attached.

FIG. 20 is a side view showing the electric motor shown in FIG. 18 to which the fixing portion is attached.

FIG. 21 is a perspective view showing the configuration of another example of an insulating case of the cold-welded conductor wire shown in FIG. 1.

FIG. 22 is a perspective view showing the configuration of a cold-welded conductor wire in embodiment 2 of the present invention.

FIG. 23 is a diagram showing a manufacturing method for the cold-welded conductor wire shown in FIG. 22.

FIG. 24 is a diagram showing the manufacturing method for the cold-welded conductor wire shown in FIG. 22.

FIG. 25 is a diagram showing the manufacturing method for the cold-welded conductor wire shown in FIG. 22.

FIG. 26 is a diagram showing the manufacturing method for the cold-welded conductor wire shown in FIG. 22.

FIG. 27 is a diagram showing the manufacturing method for the cold-welded conductor wire shown in FIG. 22.

FIG. 28 is a diagram showing the manufacturing method for the cold-welded conductor wire shown in FIG. 22.

FIG. 29 is a diagram showing the manufacturing method for the cold-welded conductor wire shown in FIG. 22.

FIG. 30 is a perspective view showing another configuration of the cold-welded conductor wire in embodiment 2 of the present invention.

FIG. 31 is a diagram showing a manufacturing method for the cold-welded conductor wire shown in FIG. 30.

FIG. 32 is a diagram showing the manufacturing method for the cold-welded conductor wire shown in FIG. 30.

FIG. 33 is a diagram showing the manufacturing method for the cold-welded conductor wire shown in FIG. 30.

FIG. 34 is a diagram showing the manufacturing method for the cold-welded conductor wire shown in FIG. 30.

FIG. 35 is a diagram showing the manufacturing method for the cold-welded conductor wire shown in FIG. 30.

FIG. 36 is a diagram showing the manufacturing method for the cold-welded conductor wire shown in FIG. 30.

FIG. 37 is a diagram showing the manufacturing method for the cold-welded conductor wire shown in FIG. 30.

FIG. 38 is a diagram showing the manufacturing method for the cold-welded conductor wire shown in FIG. 30.

### DESCRIPTION OF EMBODIMENTS

### Embodiment 1

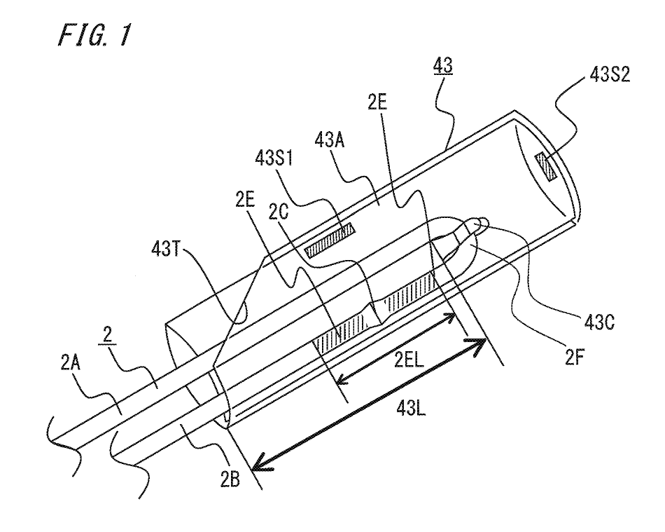

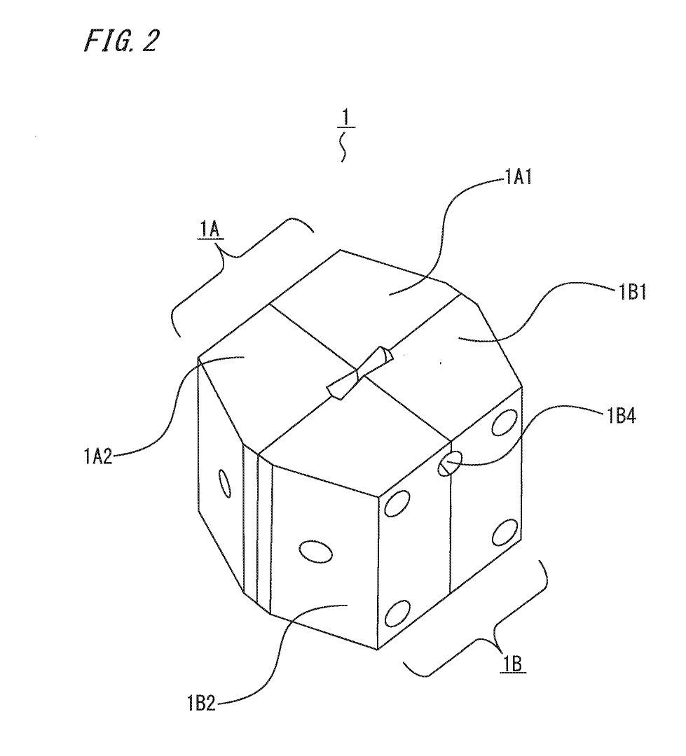

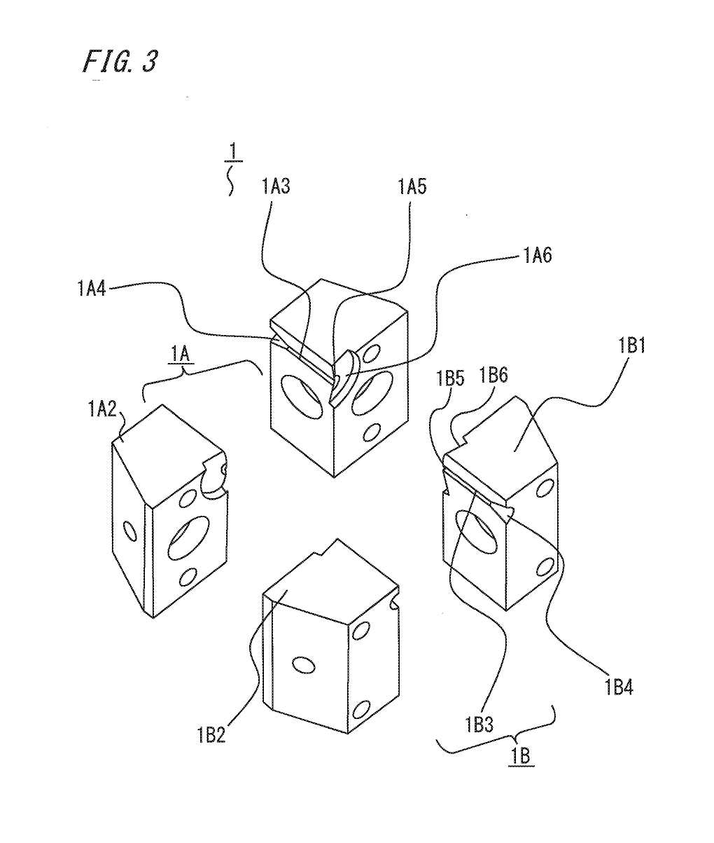

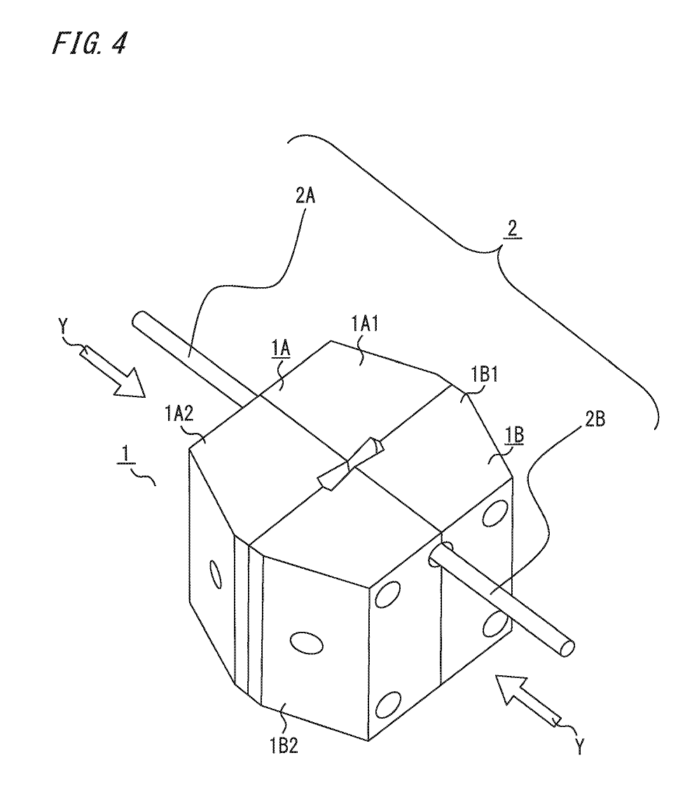

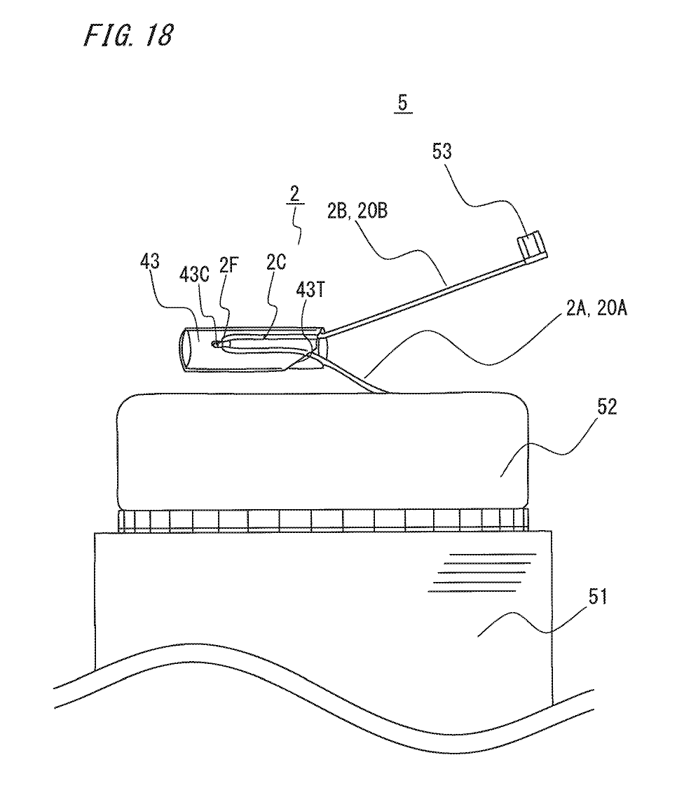

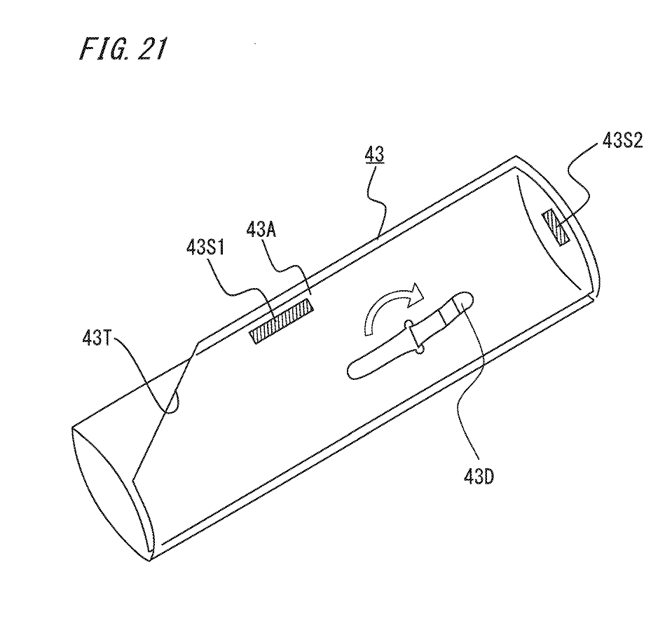

Hereinafter, embodiments of the invention of the present application will be described. FIG. 1 is a perspective view showing the configuration of a cold-welded conductor wire in embodiment 1 of the present invention. FIG. 2 is a perspective view showing the configuration of a cold welding die used in cold welding of the cold-welded conductor wire shown in FIG. 1. FIG. 3 is an exploded view showing the configuration of the cold welding die shown in FIG. 2. FIG. 4 to FIG. 17 are diagrams showing a manufacturing method for the cold-welded conductor wire shown in FIG. 1. FIG. 18 to FIG. 20 are diagrams showing the configuration of an electric motor using the cold-welded conductor wire shown in FIG. 1. FIG. 21 is a perspective view showing another configuration of an insulating case of the cold welding conductor in embodiment 1 of the present invention.

In FIG. 1, a cold-welded conductor wire 2 is composed of a first conductor wire 2A and a second conductor wire 2B connected by cold welding. A connection portion 2C is formed by the first conductor wire 2A and the second conductor wire 2B being connected by cold welding. By the cold welding, hardened portions 2E are formed near the connection portion 2C, in the first conductor wire 2A and the second conductor wire 2B. The length of the hardened portions 2E is a hardened portion length 2EL.

The hardened portions 2E are portions formed to be harder than the hardness of the materials of the first conductor wire 2A and the second conductor wire 2B. Where the hardened portions 2E are generated in the first conductor wire 2A and the second conductor wire 2B can be confirmed by measuring the first conductor wire 2A and the second conductor wire 2B by a hardness meter.

As a simple method for confirming where the hardened portions 2E are generated in the first conductor wire 2A and the second conductor wire 2B, the confirmation can be performed by bending the first conductor wire 2A and the second conductor wire 2B. The insulation property of the hardened portions 2E is lower than the insulation property of the materials of the first conductor wire 2A and the second conductor wire 2B.

Further, the cold-welded conductor wire 2 has a bent portion 2F bent at a location different from the connection portion 2C and the hardened portions 2E. The connection portion 2C and the hardened portions 2E are wrapped with an insulating sheet 43A, and the insulating sheet 43A is bonded at bonded portions 43S1 and 43S2, to form an insulating case 43. The length in which insulation can be made, of the insulating case 43 is an insulating portion length 43L. The insulating portion length 43L is a length obtained by adding an insulation distance needed for insulating the hardened portions 2E to the hardened portion length 2EL of the hardened portions 2E.

Inside the insulating case 43, a hook portion 43C is formed. The bent portion 2F is hooked and fixed at the hook portion 43C inside the insulating case 43. In the insulating case 43, a cutout 43T is formed so as to facilitate insertion of the bent portion 2F to the inside of the insulating case 43.

A cold welding die 1 (hereinafter, referred to as a die 1) for performing cold welding of the cold-welded conductor wire 2 will be described. The die 1 is composed of four of a first die piece 1A1, a second die piece 1A2, third die piece 1B1, and a fourth die piece 1B2. A first pair die 1A is a pair of the first die piece 1A1 and the second die piece 1A2, and is symmetric between right and left. A second pair die 1B is a pair of the third die piece 1B1 and the fourth die piece 1B2, and is symmetric between right and left.

The die 1 is a pair of the two first pair die 1A and second pair die 1B. The first pair die 1A has a first chuck portion 1A3 formed between abutting surfaces of the first die piece 1A1 and the second die piece 1A2 which compose the first pair die 1A. In the first chuck portion 1A3, the first conductor wire 2A is held by the first die piece 1A1 and the second die piece 1A2 abutting each other.

A first introduction portion 1A4 is formed on the insertion port side of the first chuck portion 1A3 for the first conductor wire 2A. The shape of the first introduction portion 1A4 spreads in a taper shape toward end surfaces of the first die piece 1A1 and the second die piece 1A2. The taper shape of the first introduction portion 1A4 facilitates insertion of the first conductor wire 2A into the first chuck portion 1A3.

A first abutting portion 1A5 is formed on the protrusion port side of the first chuck portion 1A3 for the first conductor wire 2A. At the first abutting portion 1A5, the first conductor wire 2A on the first pair die 1A side is caused to abut the second conductor wire 2B on the second pair die 1B side. A first burr relief portion 1A6 is formed around the first abutting portion 1A5. The first burr relief portion 1A6 is for releasing a burr 2D generated in a cold welding process of the first conductor wire 2A.

The second pair die 1B is configured in the same manner so as to be symmetric between right and left with the first pair die 1A. Thus, a second chuck portion 1B3, a second introduction portion 1B4, a second abutting portion 1B5, and a second burr relief portion 1B6 are formed, and the detailed description thereof is omitted. In the second pair die 1B, the second conductor wire 2B is held.

Next, a pressure welding machine 3 for pressing the die 1 will be described. The pressure welding machine 3 has a first V block 31 and a second V block 32 located on both sides of the die 1. Further, the pressure welding machine 3 has a first gate 3A for holding the first conductor wire 2A and a second gate 3B for holding the second conductor wire 2B.

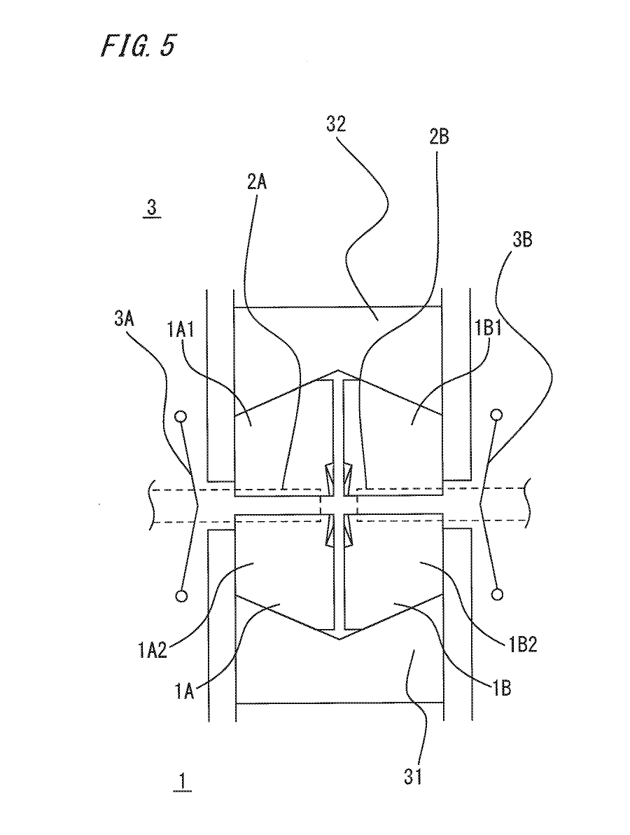

The manufacturing method for the cold-welded conductor wire configured as described above in embodiment 1 will be described. First, as shown in FIG. 5, the die pieces 1A1, 1A2, 1B1, and 1B2 are held and placed so as to be spaced from each other. Then, the conductor wires 2A and 2B are inserted into the respective chuck portions 1A3 and 1B3 from the respective introduction portions 1A4 and 1B4 of the pair dies 1A and 1B. In the state in which the conductor wires 2A and 2B are abutting each other, the first conductor wire 2A is held by the first gate 3A, and the second conductor wire 2B is held by the second gate 38.

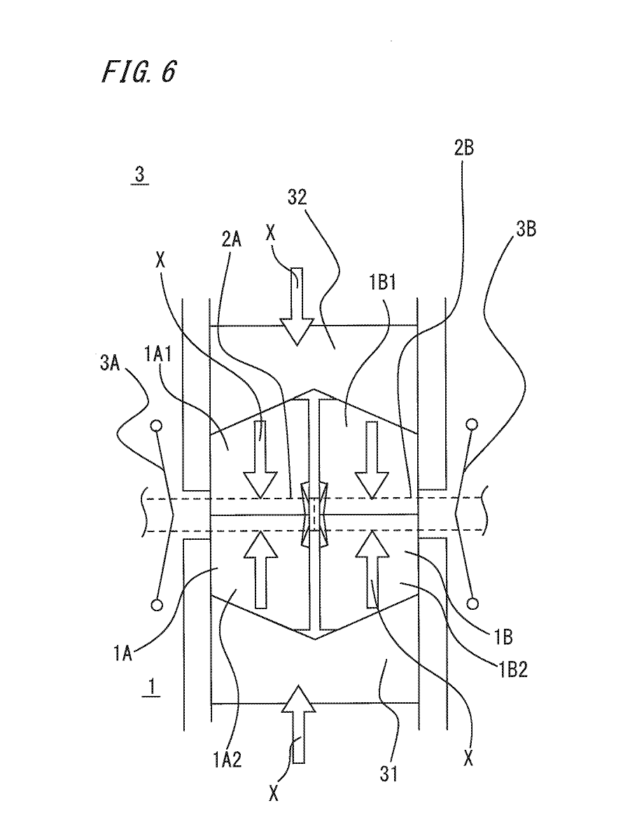

Next, as shown in FIG. 6, the V blocks 31 and 32 placed on both sides of the die I are pressed in pressing directions X. The die pieces 1A1, 1A2, 1B1, and 1B2 are moved in the pressing directions X of the V blocks 31 and 32. Then, the first conductor wire 2A is stored and held in the first chuck portion 1A3 of the first pair die 1A composed of the die pieces 1A1 and 1A2. The second conductor wire 2B is stored and held in the second chuck portion 1B3 of the second pair die 1B composed of the die pieces 1B1 and 1B2. At this time, the interval between the first pair die 1A and the second pair die 1B is still maintained.

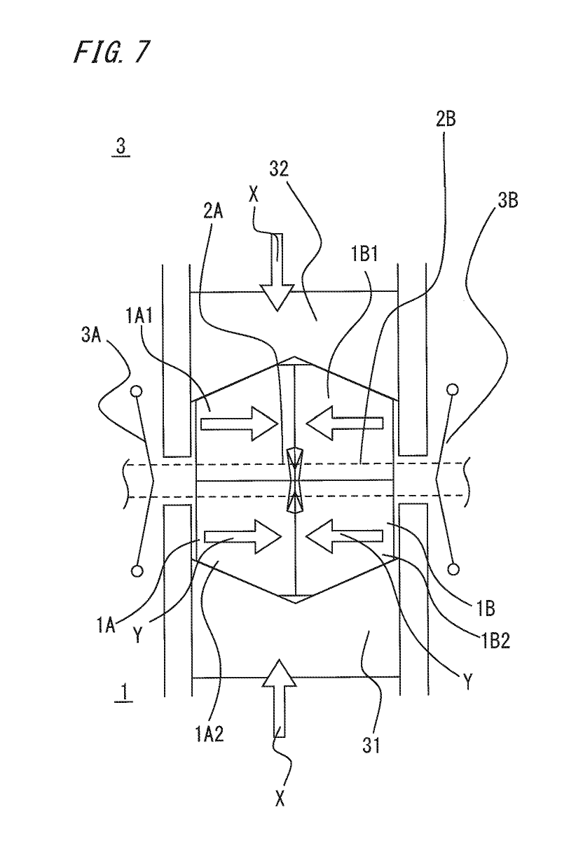

Next, as shown in FIG. 7, the V blocks 31 and 32 are further pressed in the pressing directions X. Thus, the die pieces 1A1, 1A2, 1B1, and 1B2 are moved in axial directions Y of the conductor wires 2A and 2B, along slope surfaces of the V blocks 31 and 32. Then, the pair dies 1A and 1B are caused to abut each other. Then, the conductor wires 2A and 2B held by the chuck portions 1A3 and 1B3 of the pair dies 1A and 1B are compressed and welded.

At the same time, in the vicinity of the connection portion 2C between the conductor wires 2A and 2B, the conductor wires 2A and 2B partially become burrs 2D to be extruded to the burr relief portions 1A6 and 1B6. Next, the V blocks 31 and 32 are withdrawn outward, so that, as shown in FIG. 5, the die pieces 1A1, 1A2, 1B1, and 1B2 are separated from each other to release the cold-welded conductor wire 2.

A series of these steps such as holding, pressing, and releasing of the cold-welded conductor wire 2 as shown in FIG. 5 to FIG. 7 are repeated a plurality of times. Thus, oxidized films and the impurities at the ends of the conductor wires 2A and 2B are reliably discharged as the burrs 2D to the outside, and stable cold welding can be performed.

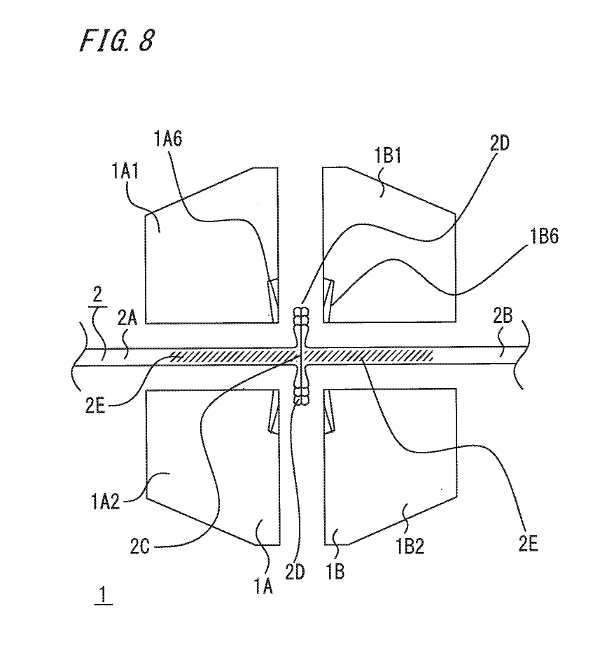

Next, as shown in FIG. 8, the conductor wires 2A and 2B are integrated at the connection portion 2C connected by cold welding, to become the cold-welded conductor wire 2. After the cold welding, the burrs 2D are formed around the connection portion 2C of the cold-welded conductor wire 2. In addition, in the vicinity of the connection portions 2C of the conductor wires 2A and 2B, the hardened portions 2E are formed at the parts held by the chuck portions 1A3 and 1B3.

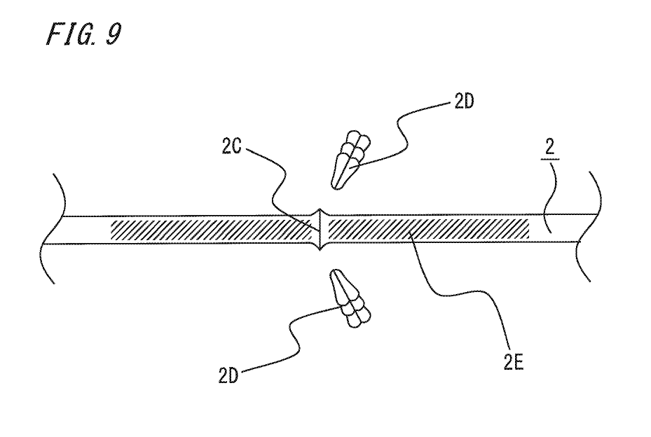

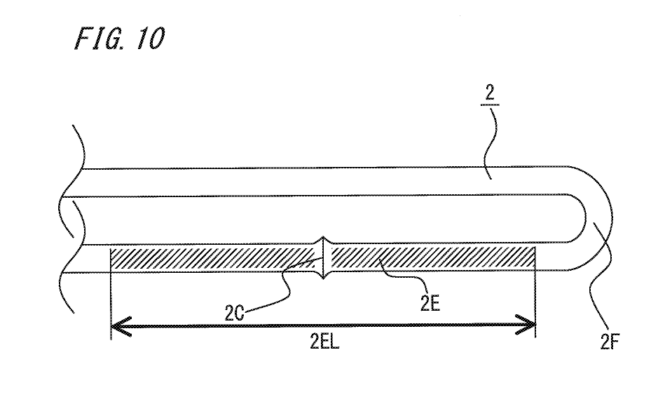

Next, as shown in FIG. 9, the burrs 2D are eliminated from the cold-welded conductor wire 2 extracted from the die 1. Thus, the connection portion 2C with no burr 2D is formed in the cold-welded conductor wire 2. Next, as shown in FIG. 10, in order to suppress damage to the connection portion 2C and the hardened portions 2E of the cold-welded conductor wire 2, the connection portion 2C and the hardened portions 2E of the cold-welded conductor wire 2 are maintained in a straight-line shape. Therefore, in the cold-welded conductor wire 2, the bent portion 2F is formed in the outside part different from the hardened portion length 2EL part including the connection portion 2C and the hardened portions 2E.

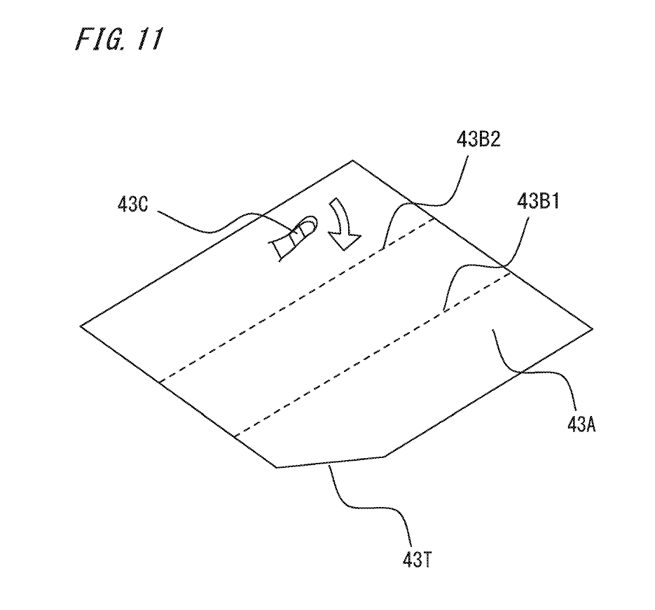

Next, as shown in FIG. 11, two fold lines 43B1 and 43B2 are formed in the rectangular insulating sheet 43A. Further, the insulating sheet 43A is partially cut out to form the cutout 43T. Further, the insulating sheet 43A is partially cut and the cut part is depressed, to form the hook portion 43C. As shown in FIG. 21, a hook portion 43D may be formed in a direction different from the direction of the hook portion 42C shown in FIG. 11, and also in this case, the following applies.

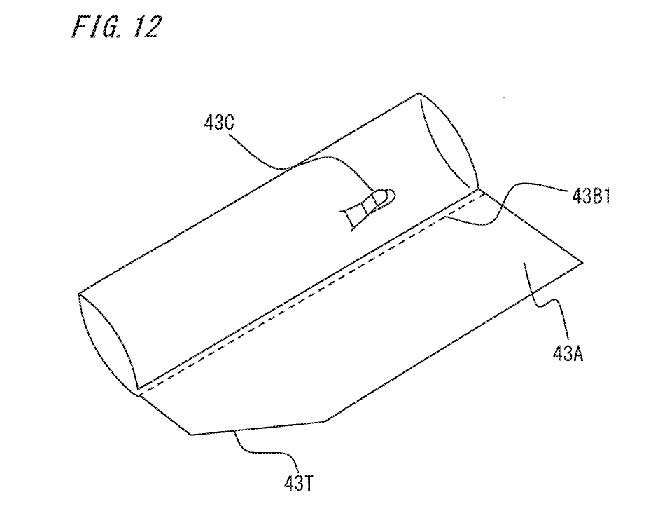

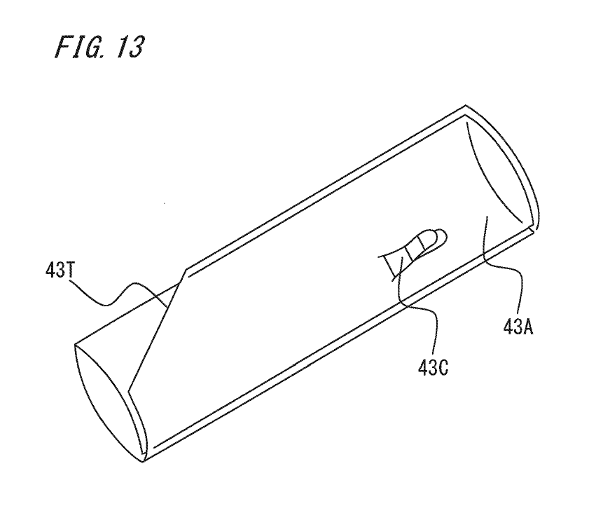

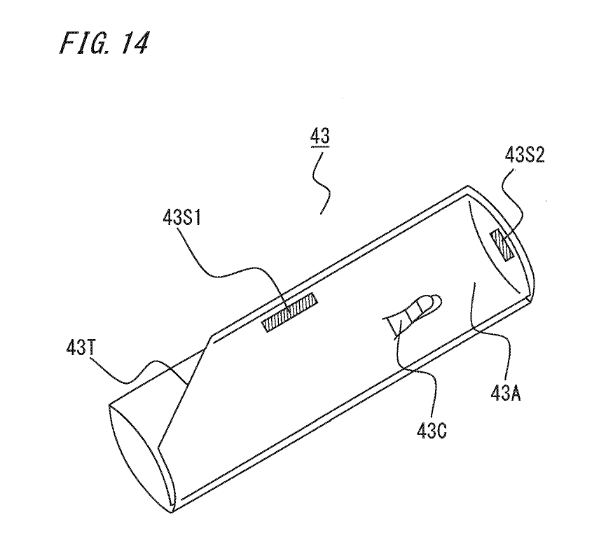

Next, as shown in FIG. 12, the insulating sheet 43A is folded inward along the fold line 43B2. Next, as shown in FIG. 13, the insulating sheet 43A is folded inward along the fold line 43B1. Next, as shown in FIG. 14, using an adhesive tape, an adhesive agent, an ultrasonic welding device, or the like, a side surface of the insulating sheet 43A is bonded at the bonded portion 43S1, and the upper end of the insulating sheet 43A is bonded at the bonded portion 43S2. Thus, the insulating case 43 is formed. As long as the insulating case 43 formed by the insulating sheet 43A is prevented from unfolding, the location where the bonded portion is formed may be shifted or the number of the bonded portions may be increased.

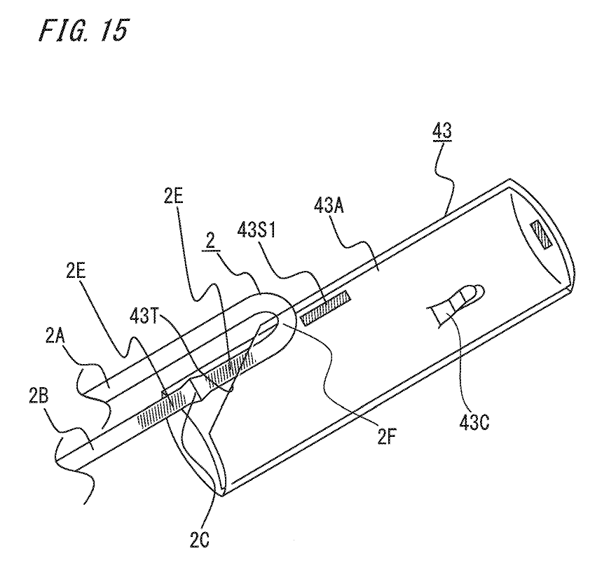

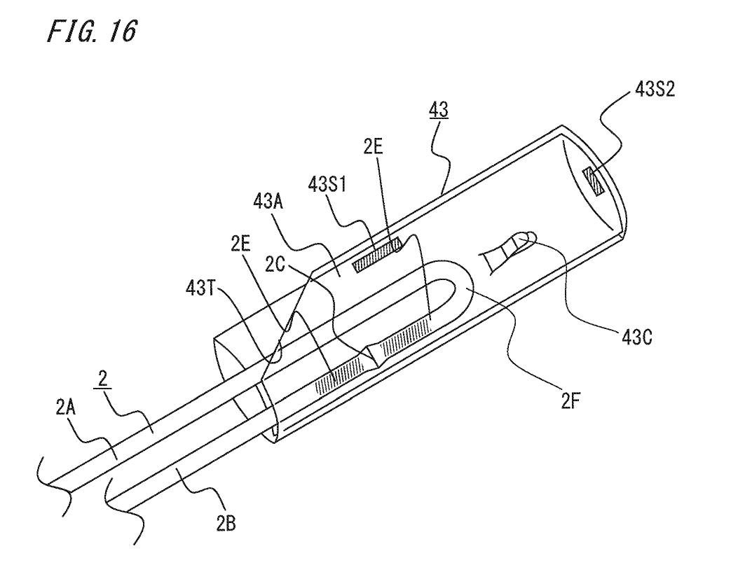

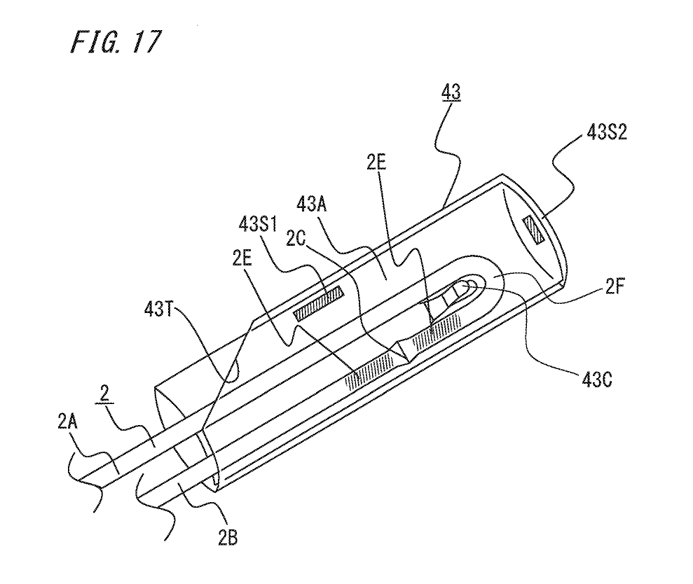

Next, as shown in FIG. 15, the bent portion 2F side of the cold-welded conductor wire 2 is inserted from a gap of the insulating case 43, i.e., from the cutout 43T. Next, as shown in FIG. 16, the cold-welded conductor wire 2 is advanced inside the insulating case 43. Next, as shown in FIG. 17, the cold-welded conductor wire 2 is further advanced inside the insulating case 43 so that the bent portion 2F of the cold-welded conductor wire 2 reaches the back of the hook portion 43C.

Next, as shown in FIG. 1, the cold-welded conductor wire 2 is drawn back so that the bent portion 2F of the cold-welded conductor wire 2 is hooked on the hook portion 43C and thereby fixed. The insulating portion length 43L of the insulating case 43 is longer than the hardened portion length 2EL including the connection portion 2C and the hardened portions 2E. Therefore, the connection portion 2C and the hardened portions 2E can be reliably insulated.

Such a cold-welded conductor wire 2 is used for an electric motor 5. As shown in FIG. 18, the electric motor 5 is composed of an iron core 51, a winding coil 52, a lead wire 20A which is an end of the winding coil 52, an external terminal 53, and an external lead wire 20B connected to the external terminal 53. As shown above, in the case where the first conductor wire 2A is assumed to be the lead wire 20A and the second conductor wire 2B is assumed to be the external lead wire 20B, similarly, cold welding is performed to form the connection portion 2C, and the insulating case 43 is formed.

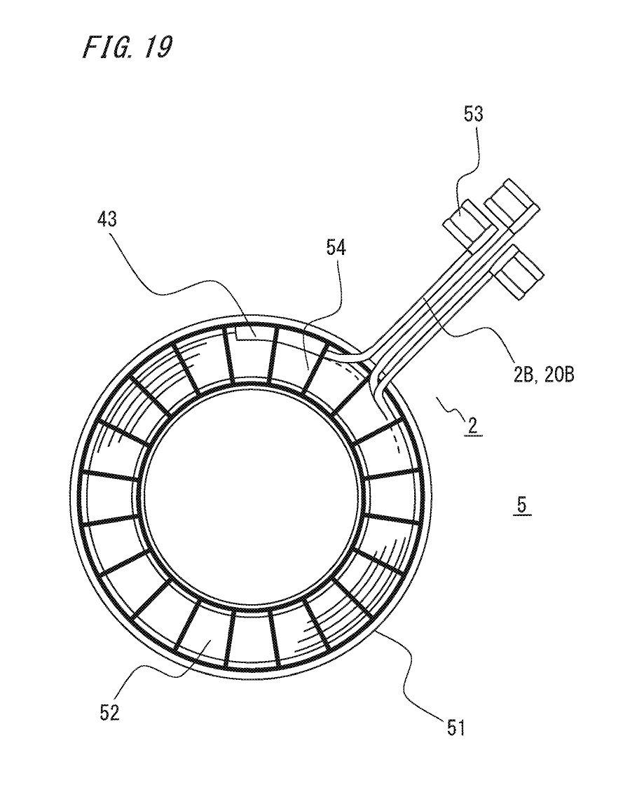

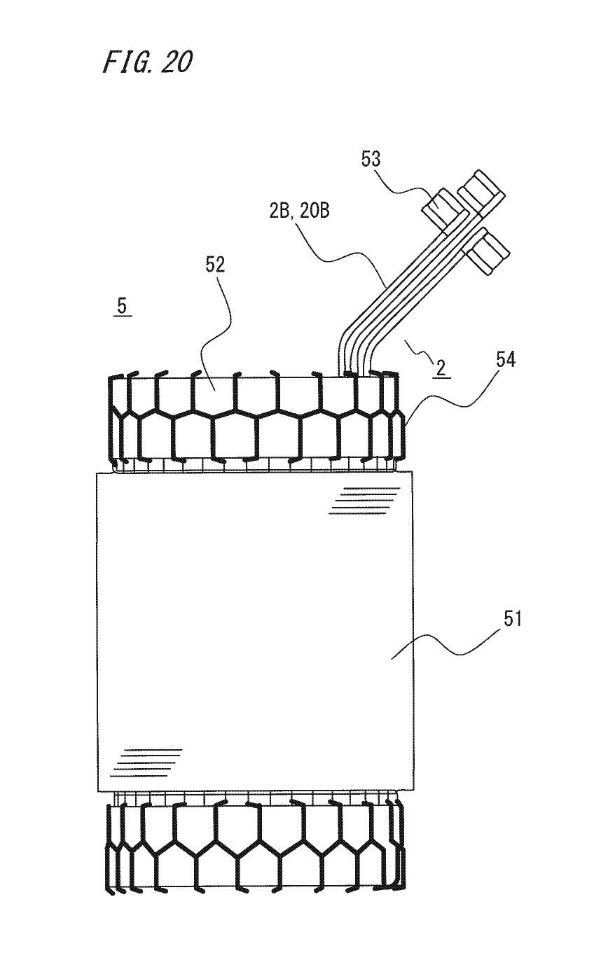

The insulating case 43 is configured so as not to be displaced to such an extent that causes the connection portion 2C of the cold-welded conductor wire 2 to be exposed or that does not allow the insulation distance to be ensured. Therefore, the insulating case 43 may be placed near the winding coil 52 of the electric motor 5, or may be inserted into a gap in the winding coil 52, to be temporarily fixed. For further reliability, as shown in FIG. 19 and FIG. 20, binding may be made over the insulating case 43 with a fixing portion 54 formed of a binding string, to fix the insulating case 43.

Thus, the insulating case 43 can be reliably fixed to the electric motor 5. The electric motor 5 in the present embodiment is a distributed winding type as an example. However, without limitation thereto, the electric motor 5 may be a concentrated winding type. The winding coil 52 may be made from a copper wire, or may be a conductor wire such as an aluminum wire other than a copper wire. Instead of being connected to the external terminal 53, the external lead wire 20B may be an intermediate member connecting the winding coil 52 and the external terminal 53.

In the cold-welded conductor wire, the electric motor, and the electric motor manufacturing method in embodiment 1 configured as described above, the connection portion and the hardened portions are maintained substantially in a straight-line shape without being bent, whereby damage to the connection portion and the hardened portions can be suppressed. In addition, since the bent portion of the cold-welded conductor wire is regulated between the bonded portion and the hook portion of the insulating sheet, relative displacement between the insulating case and the cold-welded conductor wire can be suppressed.

The insulating portion length of the insulating case is longer than a length obtained by adding the insulation distance needed for insulating the hardened portions to the hardened portion length. Therefore, even if the insulation property of the hardened portions reduces, the hardened portions can be reliably insulated by the insulating case. Therefore, for the electric motor, concern about the insulation quality in an insulation process and the subsequent assembly process can be resolved.

Before the cold-welded conductor wire is inserted into the insulating case, folding of the insulating sheet and fixation thereof by bonding can be completed. Therefore, the assembly process of the insulating case and the process for inserting the cold-welded conductor wire into the insulating case can be divided. Thus, since the processes can be divided, workability and productivity are improved. Since the insulating case is formed by folding the insulating sheet, the insulating case can be formed with low cost.

### Embodiment 2

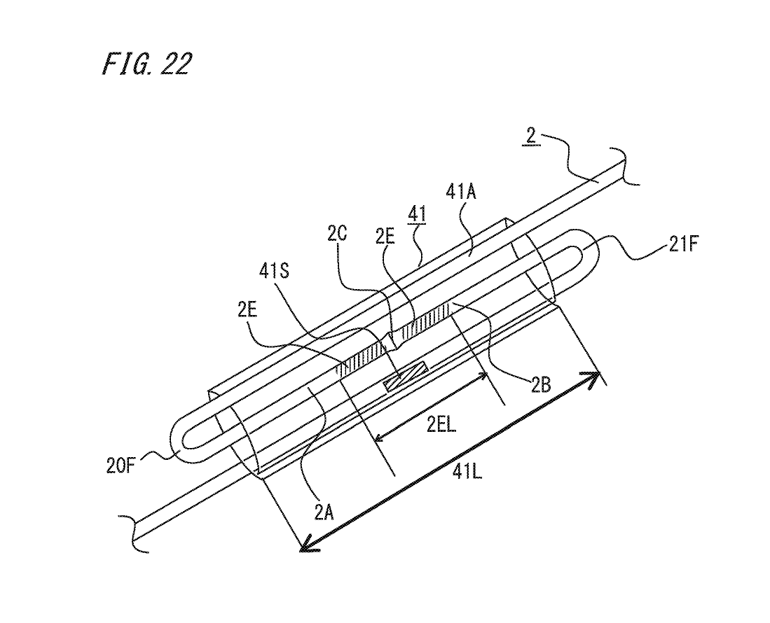

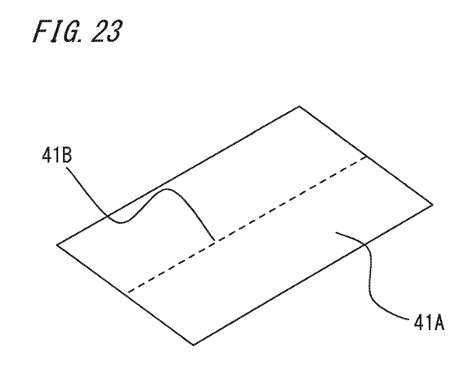

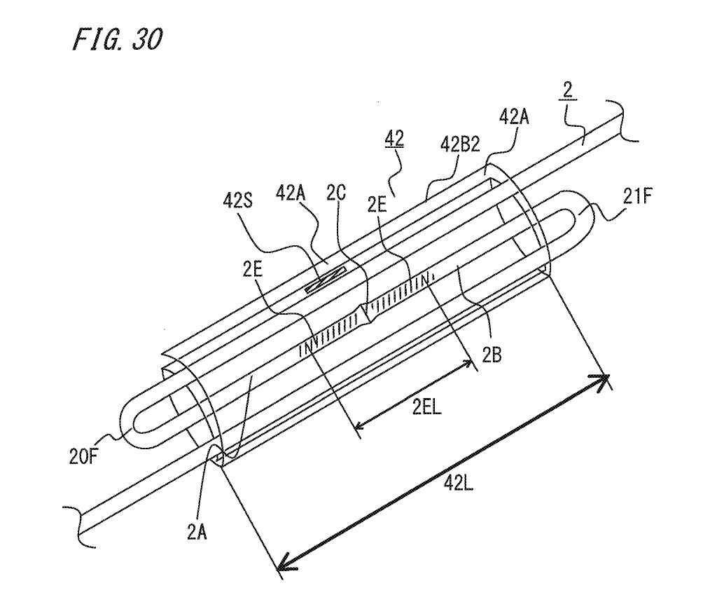

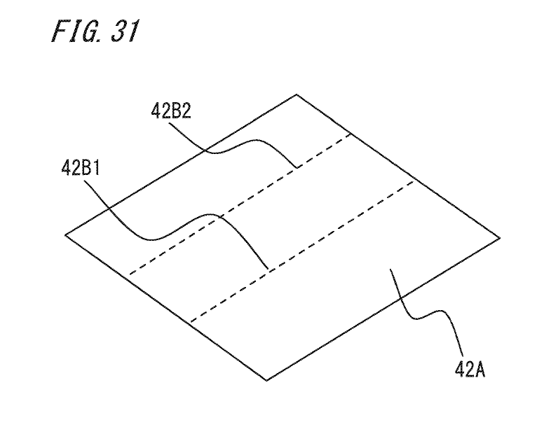

In the above embodiment 1, an example in which a hook portion is formed in the insulating case has been shown. However, without limitation thereto, in the present embodiment 2, a configuration example for forming the insulating case in a simple manner will be described. FIG. 22 is a perspective view showing the configuration of a cold-welded conductor wire in embodiment 2 of the present invention. FIG. 23 to FIG. 29 are diagrams showing a manufacturing method for the cold-welded conductor wire shown in FIG. 22. FIG. 30 is a perspective view showing another configuration of the cold-welded conductor wire in embodiment 2 of the present invention. FIG. 31 to FIG. 38 are diagrams showing a manufacturing method for the cold-welded conductor wire shown in FIG. 30.

In FIG. 22, the same parts as in the above embodiment 1 are denoted by the same reference characters, and the description thereof is omitted. The cold-welded conductor wire 2 has two bent portions 20F and 21F bent at locations different from the connection portion 2C and the hardened portions 2E. The connection portion 2C and the hardened portions 2E are wrapped with an insulating sheet 41A, and the insulating sheet 41A is bonded at a bonded portion 41S, to form an insulating case 41. The length in which insulation can be made, of the insulating case 41 is an insulating portion length 41L. The insulating portion length 41L is a length obtained by adding an insulation distance needed for insulating the hardened portions 2E to the hardened portion length 2EL of the hardened portions 2E.

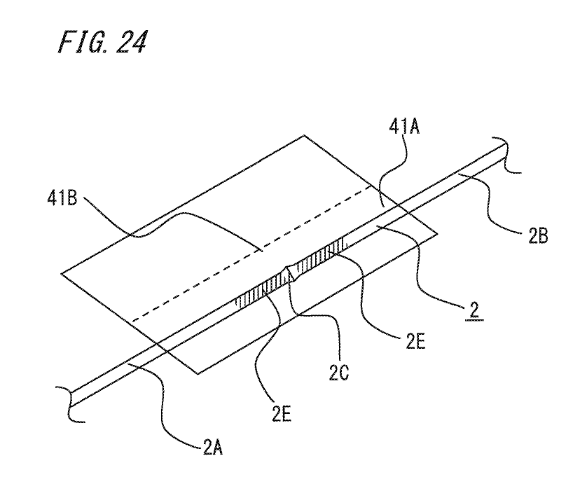

The manufacturing method for the cold-welded conductor wire configured as described above in embodiment 2 will be described. The process from connection of the conductor wires 2A and 2B by cold welding to elimination of the burrs 2D is the same as in the above embodiment 1, and therefore the description thereof is omitted. Next, as shown in FIG. 23, a fold line 41B is formed in the rectangular insulating sheet 41A. Next, as shown in FIG. 24, the cold-welded conductor wire 2 is placed such that the connection portion 2C and the hardened portions 2E of the cold-welded conductor wire 2 are placed on the insulating sheet 41A.

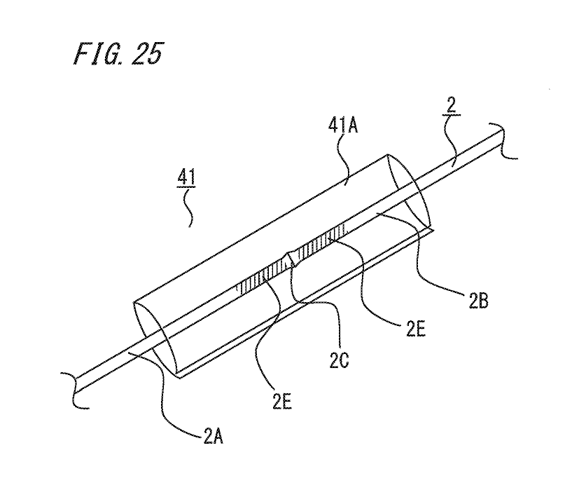

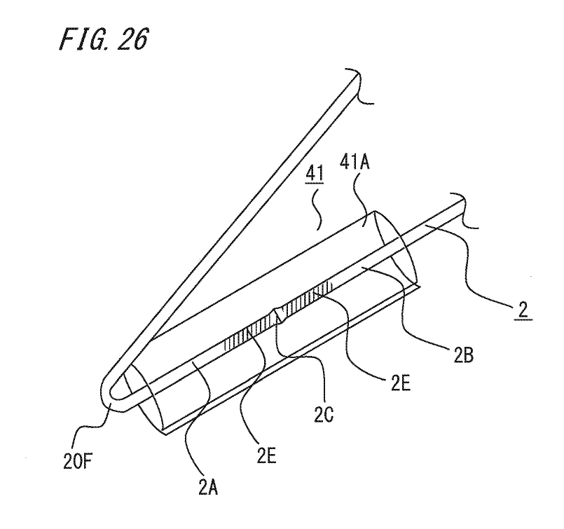

Next, as shown in FIG. 25, the insulating sheet 41A is folded inward along the fold line 41B, to cover the cold-welded conductor wire 2 with the insulating sheet 41A. That is, the connection portion 2C and the hardened portions 2E of the cold-welded conductor wire 2 are wrapped by the insulating sheet 41A. Next, as shown in FIG. 26, the cold-welded conductor wire 2 is bent at a location outside the insulating sheet 41A, to form the bent portion 20F. That is, the bent portion 20F is formed at a location different from the connection portion 2C and the hardened portions 2E of the cold-welded conductor wire 2.

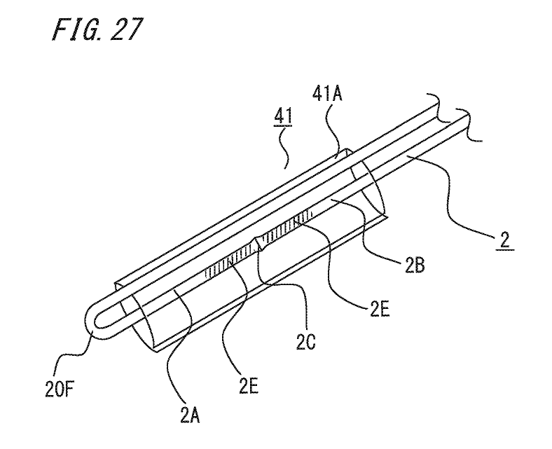

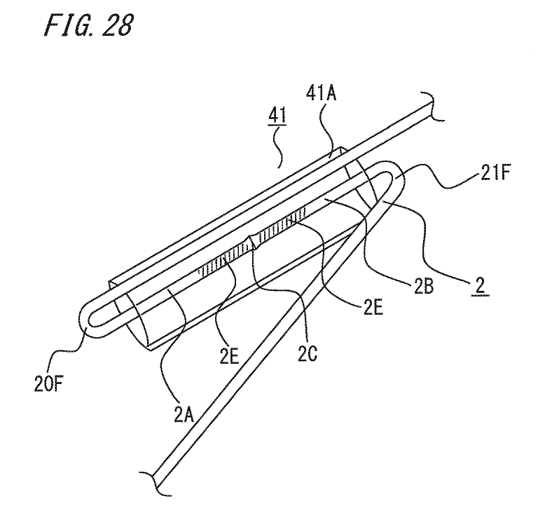

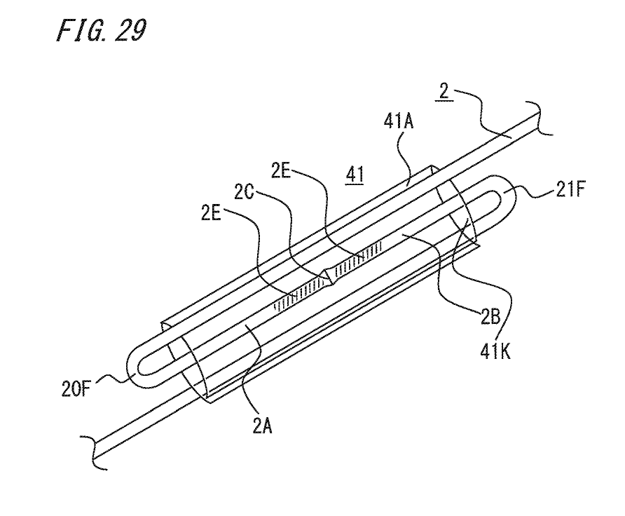

Next, as shown in FIG. 27, the part of the cold-welded conductor wire 2 bent from the bent portion 20F is made to extend along the upper surface of the insulating sheet 41A. Next, as shown in FIG. 28, the cold-welded conductor wire 2 is bent at a location outside the insulating sheet 41A and on the side opposite to the previously formed bent portion 20F, to form the bent portion 21F. That is, the bent portion 21F is formed at a location different from the connection portion 2C and the hardened portions 2E of the cold-welded conductor wire 2. Next, as shown in FIG. 29, the part of the cold-welded conductor wire 2 bent from the bent portion 21F is inserted to the inside of the insulating sheet 41A.

Next, as shown in FIG. 22, using an adhesive tape, an adhesive agent, an ultrasonic welding device, or the like, a side surface of the insulating sheet 41A is bonded at the bonded portion 41S. Thus, the insulating case 41 is formed. The insulating portion length 41L of the insulating case 41 is longer than the hardened portion length 2EL including the connection portion 2C and the hardened portions 2E. Therefore, the connection portion 2C and the hardened portions 2E can be reliably insulated. Hereinafter, an example of application to the electric motor 5 is the same as in the above embodiment 1, and therefore the description thereof is omitted.

Next, another example will be described. In FIG. 30, the same parts as in the above embodiment 1 are denoted by the same reference characters, and the description thereof is omitted. As in the case of FIG. 22, the cold-welded conductor wire 2 has two bent portions 20F and 21F bent at locations different from the connection portion 2C and the hardened portions 2E. The connection portion 2C and the hardened portions 2E are wrapped with an insulating sheet 42A, and the insulating sheet 42A is bonded at a bonded portion 42S, to form an insulating case 42. The length in which insulation can be made, of the insulating case 42 is an insulating portion length 42L. The insulating portion length 42L is a length obtained by adding an insulation distance needed for insulating the hardened portions 2E to the hardened portion length 2EL of the hardened portions 2E.

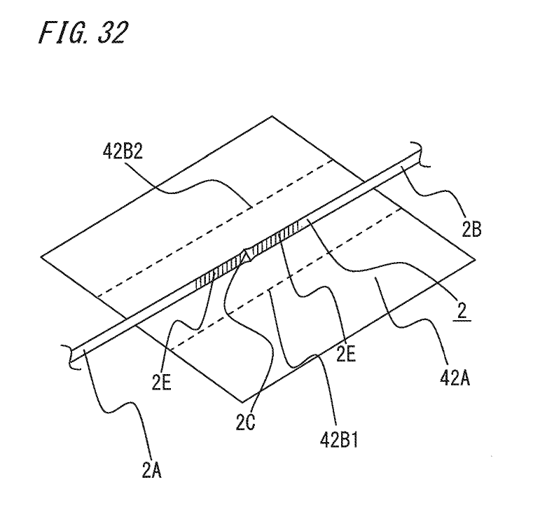

Another manufacturing method for the cold-welded conductor wire configured as described above in embodiment 2 will be described. The process from connection of the conductor wires 2A and 2B by cold welding to elimination of the burrs 2D is the same as in the above embodiment 1, and therefore the description thereof is omitted. Next, as shown in FIG. 31, fold lines 42B1 and 42B2 are formed in the rectangular insulating sheet 42A. Next, as shown in FIG. 32, the cold-welded conductor wire 2 is placed such that the connection portion 2C and the hardened portions 2E of the cold-welded conductor wire 2 are placed on the central area on the insulating sheet 42A.

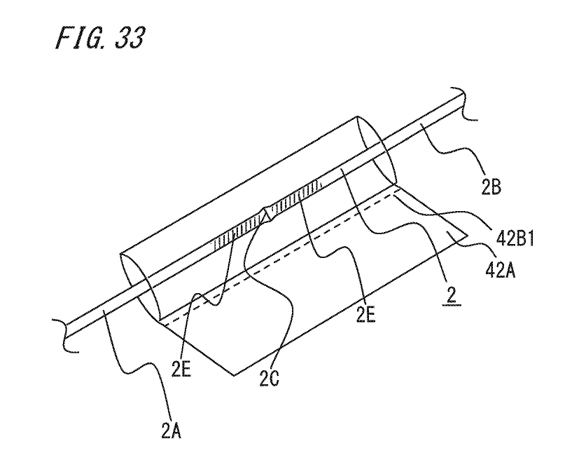

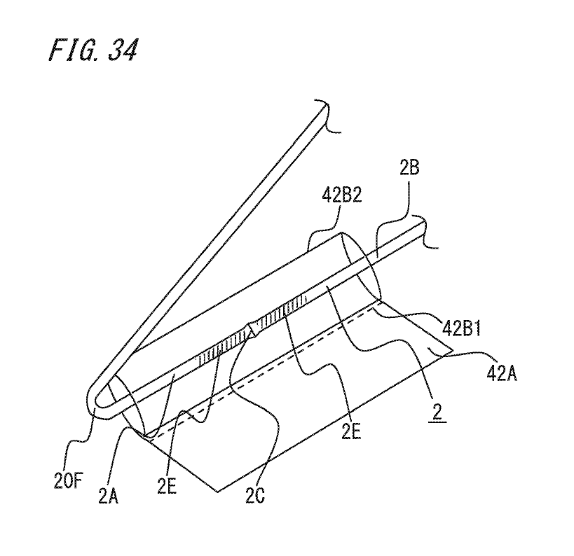

Next, as shown in FIG. 33, the insulating sheet 42A is folded inward along the fold line 42B2, to cover the cold-welded conductor wire 2 with the insulating sheet 42A. That is, the connection portion 2C and the hardened portions 2E of the cold-welded conductor wire 2 are wrapped by the insulating sheet 42A. Next, as shown in FIG. 34, the cold-welded conductor wire 2 is bent at a location outside the insulating sheet 41A, to form the bent portion 20F. That is, the bent portion 20F is formed at a location different from the connection portion 2C and the hardened portions 2E of the cold-welded conductor wire 2.

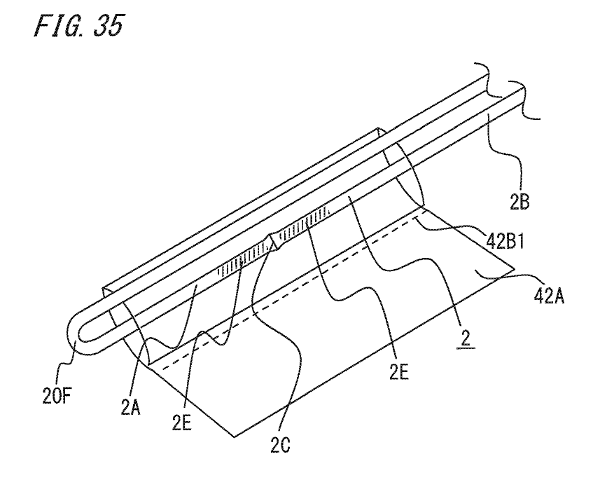

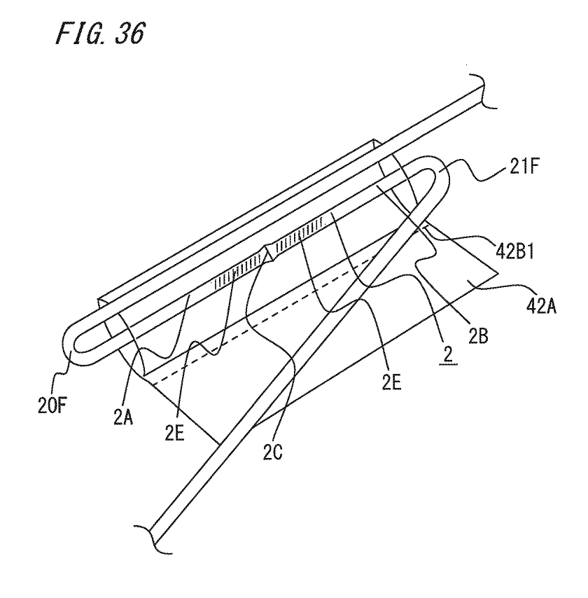

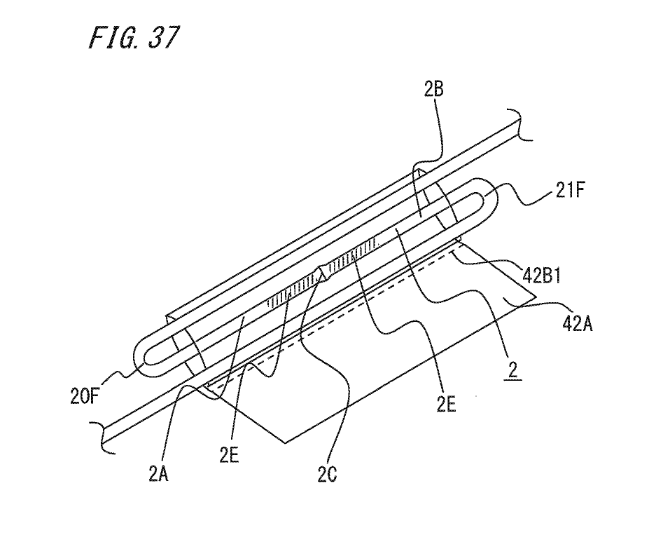

Next, as shown in FIG. 35, the part of the cold-welded conductor wire 2 bent from the bent portion 20F is made to extend along the upper surface of the insulating sheet 42A. Next, as shown in FIG. 36, the cold-welded conductor wire 2 is bent at a location outside the insulating sheet 41A and on the side opposite to the previously formed bent portion 20F, to form the bent portion 21F. That is, the bent portion 21F is formed at a location different from the connection portion 2C and the hardened portions 2E of the cold-welded conductor wire 2. Next, as shown in FIG. 37, the part of the cold-welded conductor wire 2 bent from the bent portion 21F is made to extend along the upper surface of the insulating sheet 42A.

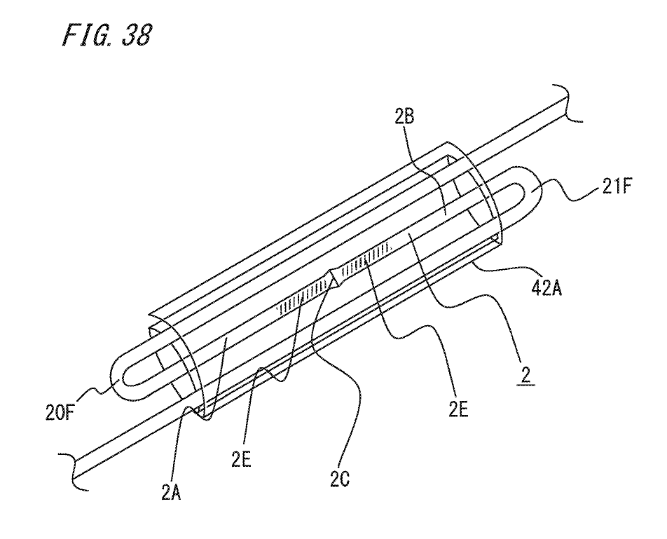

Next, as shown in FIG. 38, the insulating sheet 42A is folded inward along the fold line 42B1, to cover the cold-welded conductor wire 2 bent at the bent portions 20F and 21F, with the insulating sheet 42A. Next, as shown in FIG. 30, using an adhesive tape, an adhesive agent, an ultrasonic welding device, or the like, a side surface of the insulating sheet 42A is bonded at the bonded portion 42S. Thus, the insulating case 42 is formed.

The insulating portion length 42L of the insulating case 42 is longer than the hardened portion length 2EL including the connection portion 2C and the hardened portions 2E. Therefore, the connection portion 2C and the hardened portions 2E can be reliably insulated. Hereinafter, an example of application to the electric motor 5 is the same as in the above embodiment 1, and therefore the description thereof is omitted.

The cold-welded conductor wire, the electric motor, and the electric motor manufacturing method configured as described above in embodiment 2 enable the insulating case to be formed in a simple manner, as well as providing the same effect as in the above embodiment 1.

In the above embodiments, the case where the bent portions are formed at locations different from the connection portion and the hardened portions has been shown. However, unless the insulation property and the strength of the hardened portions are influenced, the bent portions only need to be formed at locations different from the connection portion, whereby the same effect as in the above embodiments can be provided.

In the above embodiments, an example in which the insulating sheet is formed so as to wrap the connection portion and the hardened portions has been shown. However, unless the insulation property of the hardened portions is influenced, the insulating sheet only needs to be formed so as to wrap the connection portion, whereby the same effect as in the above embodiments can be provided.

It is noted that, within the scope of the present invention, the above embodiments may be freely combined with each other, or each of the above embodiments may be modified or abbreviated as appropriate.

1-14. (canceled)

15. A conductor wire having a connection portion, the conductor wire comprising:
a bent portion formed in at least one location different from the connection portion and on both sides of the connection portion; and
an insulator having a cylindrical shape and covering the connection portion, wherein
a position of the insulator in an axial direction of the conductor wire is regulated by the bent portion.

16. The conductor wire according to claim 15, wherein
the insulator is an insulating case formed by rolling and bonding an insulating sheet.

17. The conductor wire according to claim 15, wherein
the insulator covers the conductor wire on an outer side of the bent portion with respect to the connection portion.

18. The conductor wire according to claim 16, wherein
the insulator covers the conductor wire on an outer side of the bent portion with respect to the connection portion.

19. An electric motor having a winding coil and an external lead wire, the electric motor comprising:
a bent portion formed in at least one location different from a connection portion between a lead wire of the winding coil and the external lead wire, and on both sides of the connection portion; and
an insulator having a cylindrical shape and covering the connection portion, wherein
a position of the insulator in an axial direction of the winding coil and the external lead wire is regulated by the bent portion.

20. The electric motor according to claim 19, wherein
the insulator is an insulating case formed by rolling and bonding an insulating sheet.

21. The electric motor according to claim 19, wherein
the insulator covers a lead wire of the winding coil and the external lead wire on an outer side of the bent portion with respect to the connection portion.

22. The electric motor according to claim 21, wherein
the insulator covers a lead wire of the winding coil and the external lead wire on an outer side of the bent portion with respect to the connection portion.

23. The electric motor according to claims 19, further comprising a fixing portion for fixing the insulator to the winding coil.

24. A manufacturing method for an electric motor having a winding coil and an external lead wire, the manufacturing method comprising:
a step of connecting a lead wire of the winding coil and the external lead wire, to form a connection portion;
a step of covering the connection portion with an insulator; and
a step of forming a bent portion in at least one location different from the connection portion and on both sides of the connection portion.

25. The manufacturing method for the electric motor according to claim 24, further comprising a step of fixing the insulator to the winding coil.
